(19) United States
(12) Patent Application Publication
(10) Pub. No.: US 2025/0209343 A1
(43) Pub. Date: Jun. 26, 2025

(54) APPARATUS & METHOD FOR FEDERATED LEARNING

(71) Applicant: Nokia Technologies Oy, Espoo (FI)

(72) Inventors: Mohammad MALEKZADEH, Cambridge (GB); Francesco PASE, Cambridge (GB); Dimitrios SPATHIS, Cambridge (GB); Soumyajit CHATTERJEE, Cambridge (GB); Ryuhaerang CHOI, Cambridge (GB); Aashish KOLLURI, Cambridge (GB)

(21) Appl. No.: 18/988,518

(22) Filed: Dec. 19, 2024

(30) Foreign Application Priority Data
Dec. 21, 2023 (FI) 20236408

(51) Int. Cl. G06N 3/098

(52) U.S. Cl. CPC G06N 3/098

(57) ABSTRACT

Apparatus comprising means for: receiving a machine learning model, wherein the machine learning model is configured to classify input data into a plurality of classes; receiving a per-class performance of the machine learning model; obtaining a data distribution of a local data set; determining, based on the data distribution of the local data set, if training the machine learning model with the local data set will change the per-class performance of the machine learning model; and in response to determining that training the machine learning model with the local data set will change the per-class performance of the machine learning model: training the machine learning model using the local data set.

### FIELD

Various example embodiments relate to an apparatus & a method for Federated Learning.

### BACKGROUND

Federated Learning is a machine learning technique where a global machine learning model is trained by a plurality of client devices over a plurality of training rounds. In each training round the server transmits the global machine learning model to the plurality of client devices. Each device in the plurality of client devices locally trains the machine learning model based on a local data set and transmits the updated machine learning model to the server. This process is repeated for a plurality of training rounds (e.g. until the global machine learning model has an acceptable performance).

Repeatedly training the machine learning model at the client device in each training round can consume a lot of resources (e.g. energy and/or processing resources). This can be problematic for resource constrained devices.

### SUMMARY

According to a first aspect there is provided an apparatus comprising means for: receiving a machine learning model, wherein the machine learning model is configured to classify input data into a plurality of classes; receiving a per-class performance of the machine learning model; obtaining a data distribution of a local data set; determining, based on the data distribution of the local data set, if training the machine learning model with the local data set will change the per-class performance of the machine learning model; and in response to determining that training the machine learning model with the local data set will change the per-class performance of the machine learning model: training the machine learning model using the local data set.

In an example, the apparatus further comprises means for maintaining (e.g. not training) the machine learning model using the local data set in response to determining that training the machine learning model with the local data set will not change the per-class performance of the machine learning model.

In an example determining, based on the data distribution of the local data set, if training the machine learning model with the local data set will change the per-class performance of the machine learning model is performed before training the machine learning model with the local data set.

In an example determining if training the machine learning model with the local data set will change the per-class performance of the machine learning model comprises determining if training the machine learning model with the local data set is likely to change the per-class performance of the machine learning model.

In an example receiving the machine learning model comprises receiving information indicating the machine learning model (e.g. weights, biases and/or structure).

In an example the apparatus further comprises means for: transmitting model updates after training the machine learning model.

In an example the model updates are transmitted to a server.

In an example the model updates comprise at least one of: weights of the machine learning model after training; or differences between weights of the machine learning model before training and after training.

In an example determining if training the machine learning model with the local data set will change the per-class performance of the machine learning model comprises: comparing the data distribution of the local data set and the per-class performance of the machine learning model.

In an example comparing the data distribution of the local data set and the per-class performance of the machine learning model comprises: determining a first ranking for the plurality of classes based on the data distribution of the local data set; determining a second ranking for the plurality of classes based on the per-class performance; determining a difference between the first ranking and the second ranking; and determining that training the machine learning model with the local data set will change the per-class performance of the machine learning model in response to determining that the difference is greater than a first threshold. Optionally, greater than or equal to the first threshold.

In an example the per-class performance comprises information indicating a performance of the machine learning model for classifying a first class in the plurality of classes; and the data distribution of the local data set comprises information indicating a proportion of the local data set associated with the first class in the plurality of classes.

In an example the per-class performance comprises information indicating a performance of the machine learning model for classifying each class in the plurality of classes; and the data distribution of the local data set comprises information indicating a proportion of the local data set associated with each class in the plurality of classes.

In an example determining the first ranking for the plurality of classes based on the per-class performance comprises: ranking the first class in the plurality of classes based on the performance of the machine learning model for classifying the first class; and determining the second ranking for the plurality of classes based on the data distribution of the local data set comprises: ranking the first class in the plurality of classes based on the proportion of the local data set associated with the first class.

In an example the apparatus further comprises means for: determining an updated per-class performance of the machine learning model after training the machine learning model; and transmitting information indicating the updated per-class performance.

In an example transmitting information indicating the updated per-class performance comprises: generating an obscured per-class performance based on the updated per-class performance; transmitting the obscured per-class performance.

In an example generating the obscured per-class performance based on the updated per-class performance comprises: modifying the updated per-class performance with a randomly generated noise value.

In an example generating the obscured per-class performance based on the updated per-class performance comprises: encrypting the updated per-class performance with a private encryption key.

In an example the private encryption key is a homomorphic encryption key.

In an example obtaining the per-class performance of the machine learning model comprises: receiving an encrypted version of the per-class performance; and decrypting the encrypted version of the per-class performance using the private encryption key to obtain the per-class performance.

In an example the per-class performance of the machine learning model comprises a per-class accuracy of the machine learning model.

In an example the local data set is only known to the apparatus.

In an example the machine learning model comprises an Artificial Neural Network.

According to a second aspect there is provided a method comprising: receiving a machine learning model, wherein the machine learning model is configured to classify input data into a plurality of classes; receiving a per-class performance of the machine learning model; obtaining a data distribution of a local data set; determining, based on the data distribution of the local data set, if training the machine learning model with the local data set will change the per-class performance of the machine learning model; and in response to determining that training the machine learning model with the local data set will change the per-class performance of the machine learning model: training the machine learning model using the local data set.

In an example the method is computer-implemented.

In an example the method further comprises: transmitting model updates after training the machine learning model.

In an example determining if training the machine learning model with the local data set will change the per-class performance of the machine learning model comprises: comparing the data distribution of the local data set and the per-class performance of the machine learning model.

In an example comparing the data distribution of the local data set and the per-class performance of the machine learning model comprises: determining a first ranking for the plurality of classes based on the data distribution of the local data set; determining a second ranking for the plurality of classes based on the per-class performance; determining a difference between the first ranking and the second ranking; and determining that training the machine learning model with the local data set will change the per-class performance of the machine learning model in response to determining that the difference is greater than a first threshold.

In an example the per-class performance comprises information indicating a performance of the machine learning model for classifying a first class in the plurality of classes; and the data distribution of the local data set comprises information indicating a proportion of the local data set associated with the first class in the plurality of classes.

In an example determining the first ranking for the plurality of classes based on the per-class performance comprises: ranking the first class in the plurality of classes based on the performance of the machine learning model for classifying the first class; and determining the second ranking for the plurality of classes based on the data distribution of the local data set comprises: ranking the first class in the plurality of classes based on the proportion of the local data set associated with the first class.

In an example the method further comprises: determining an updated per-class performance of the machine learning model after training the machine learning model; and transmitting information indicating the updated per-class performance.

In an example transmitting information indicating the updated per-class performance comprises: generating an obscured per-class performance based on the updated per-class performance; and transmitting the obscured per-class performance.

In an example generating the obscured per-class performance based on the updated per-class performance comprises: modifying the updated per-class performance with a randomly generated noise value.

In an example generating the obscured per-class performance based on the updated per-class performance comprises: encrypting the updated per-class performance with a private encryption key.

In an example obtaining the per-class performance of the machine learning model comprises: receiving an encrypted version of the per-class performance; and decrypting the encrypted version of the per-class performance using the private encryption key to obtain the per-class performance.

In an example the per-class performance of the machine learning model comprises a per-class accuracy of the machine learning model.

In an example the local data set is only known to the apparatus.

In an example the machine learning model comprises an Artificial Neural Network.

According to a third aspect there is provided a computer program comprising instructions which, when executed by an apparatus, cause the apparatus to perform at least the following: receiving a machine learning model, wherein the machine learning model is configured to classify input data into a plurality of classes; receiving a per-class performance of the machine learning model; obtaining a data distribution of a local data set; determining, based on the data distribution of the local data set, if training the machine learning model with the local data set will change the per-class performance of the machine learning model; and in response to determining that training the machine learning model with the local data set will change the per-class performance of the machine learning model: training the machine learning model using the local data set.

According to a fourth aspect there is provided a non-transitory computer readable medium comprising program instructions that, when executed by an apparatus cause the apparatus to perform at least the following: receiving a machine learning model, wherein the machine learning model is configured to classify input data into a plurality of classes; receiving a per-class performance of the machine learning model; obtaining a data distribution of a local data set; determining, based on the data distribution of the local data set, if training the machine learning model with the local data set will change the per-class performance of the machine learning model; and in response to determining that training the machine learning model with the local data set will change the per-class performance of the machine learning model: training the machine learning model using the local data set.

According to a fifth aspect there is provided an apparatus comprising: at least one processor; and at least one memory storing instructions that, when executed by the at least one processor, cause the apparatus at least to perform: receiving a machine learning model, wherein the machine learning model is configured to classify input data into a plurality of classes; receiving a per-class performance of the machine learning model; obtaining a data distribution of a local data set; determining, based on the data distribution of the local data set, if training the machine learning model with the local data set will change the per-class performance of the machine learning model; and in response to determining that training the machine learning model with the local data set will change the per-class performance of the machine learning model: training the machine learning model using the local data set.

According to a sixth aspect there is provided an apparatus comprising means for: transmitting a machine learning model, wherein the machine learning model is configured to classify input data into a plurality of classes; transmitting a per-class performance of the machine learning model; receiving at least one model update to the machine learning model; updating the machine learning model based on the at least one model update; and determining the per-class performance of the machine learning model after updating the machine learning model.

In an example determining the per-class performance of the machine learning model after updating the machine learning model comprises: calculating the per-class performance of the machine learning model with a test data set.

In an example the apparatus further comprises means for: receiving, from a first client device, first information indicating a per-class performance of a first machine learning model; obtaining second information indicating a per-class performance indicating a per-class performance of a second machine learning model trained by a second client device; and wherein: determining the per-class performance of the machine learning model after updated the machine learning model, comprises determining the per-class performance of the machine learning model based on the first information and the second information.

In an example the first information is received in a first training round and wherein: the second information is associated with a previous training round and is obtained in response to determining that the second client device has not participated in the first training round.

In an example the first training round occurs after the previous training round. In an example the second information is received in a previous training round.

In an example determining the per-class performance of the machine learning model based on the first information and the second information comprises averaging the first information and the second information.

In an example the first information comprises at least one of: a modified version of the per-class performance of the first machine learning model.

In an example the modified version of the per-class performance from the first client device comprises at least one of: an encrypted version of the per-class performance of the first machine learning model; or a noisy version of the per-class performance from the first machine learning model.

According to a seventh aspect there is provided a method comprising: transmitting a machine learning model, wherein the machine learning model is configured to classify input data into a plurality of classes; transmitting a per-class performance of the machine learning model; receiving at least one model update to the machine learning model; updating the machine learning model based on the at least one model update; and determining the per-class performance of the machine learning model after updating the machine learning model.

In an example the method is computer-implemented.

In an example determining the per-class performance of the machine learning model after updating the machine learning model comprises: calculating the per-class performance of the machine learning model with a test data set.

In an example the method further comprises: receiving, from a first client device, first information indicating a per-class performance of a first machine learning model; obtaining second information indicating a per-class performance indicating a per-class performance of a second machine learning model trained by a second client device; and wherein: determining the per-class performance of the machine learning model after updated the machine learning model, comprises determining the per-class performance of the machine learning model based on the first information and the second information.

In an example the first information is received in a first training round and wherein: the second information is associated with a previous training round and is obtained in response to determining that the second client device has not participated in the first training round.

In an example determining the per-class performance of the machine learning model based on the first information and the second information comprises averaging the first information and the second information.

In an example the first information comprises at least one of: a modified version of the per-class performance of the first machine learning model.

In an example the modified version of the per-class performance from the first client device comprises at least one of: an encrypted version of the per-class performance of the first machine learning model; or a noisy version of the per-class performance from the first machine learning model.

According to an eighth aspect there is provided a computer program comprising instructions which, when executed by an apparatus, cause the apparatus to perform at least the following: transmitting a machine learning model, wherein the machine learning model is configured to classify input data into a plurality of classes; transmitting a per-class performance of the machine learning model; receiving at least one model update to the machine learning model; updating the machine learning model based on the at least one model update; and determining the per-class performance of the machine learning model after updating the machine learning model.

According to a ninth aspect there is provided a non-transitory computer readable medium comprising program instructions that, when executed by an apparatus cause the apparatus to perform at least the following: transmitting a machine learning model, wherein the machine learning model is configured to classify input data into a plurality of classes; transmitting a per-class performance of the machine learning model; receiving at least one model update to the machine learning model; updating the machine learning model based on the at least one model update; and determining the per-class performance of the machine learning model after updating the machine learning model.

According to a tenth aspect there is provided an apparatus comprising: at least one processor; and at least one memory storing instructions that, when executed by the at least one processor, cause the apparatus at least to perform: transmitting a machine learning model, wherein the machine learning model is configured to classify input data into a plurality of classes; transmitting a per-class performance of the machine learning model; receiving at least one model update to the machine learning model; updating the machine learning model based on the at least one model update; and determining the per-class performance of the machine learning model after updating the machine learning model.

According to an eleventh aspect there is provided a system comprising: a client apparatus; and a server apparatus, wherein: the client apparatus comprises means for: receiving a machine learning model, wherein the machine learning model is configured to classify input data into a plurality of classes; receiving a per-class performance of the machine learning model; obtaining a data distribution of a local data set; determining, based on the data distribution of the local data set, if training the machine learning model with the local data set will change the per-class performance of the machine learning model; and in response to determining that training the machine learning model with the local data set will change the per-class performance of the machine learning model: training the machine learning model using the local data set; and wherein the server apparatus comprises means for: transmitting the machine learning model; transmitting the per-class performance of the machine learning model; receiving at least one model update to the machine learning model; updating the machine learning model based on the at least one model update; and determining the per-class performance of the machine learning model after updating the machine learning model.

### BRIEF DESCRIPTION OF THE DRAWINGS

Some examples will now be described with reference to the accompanying drawings in which:

FIG. 1 shows a system 100 according to an example;

FIG. 2 shows a per-class accuracy during training according to an example;

FIG. 3 shows a method performed by a server according to an example;

FIG. 4 shows a method performed by a client device according to an example;

FIG. 5 shows a method performed by the client device according to a second example;

FIG. 6A shows a first variant of a method performed by the client device according to an example;

FIG. 6B shows a first variant of a method performed by the server according to an example;

FIG. 7 shows a second variant of a method performed by the server according to an example;

FIG. 8A shows an illustration of a fully connected (artificial) neural network according to an example;

FIG. 8B shows an implementation of the first client device 101 according to an example.

In the figures same reference numerals denote same functionality/components.

### DETAILED DESCRIPTION

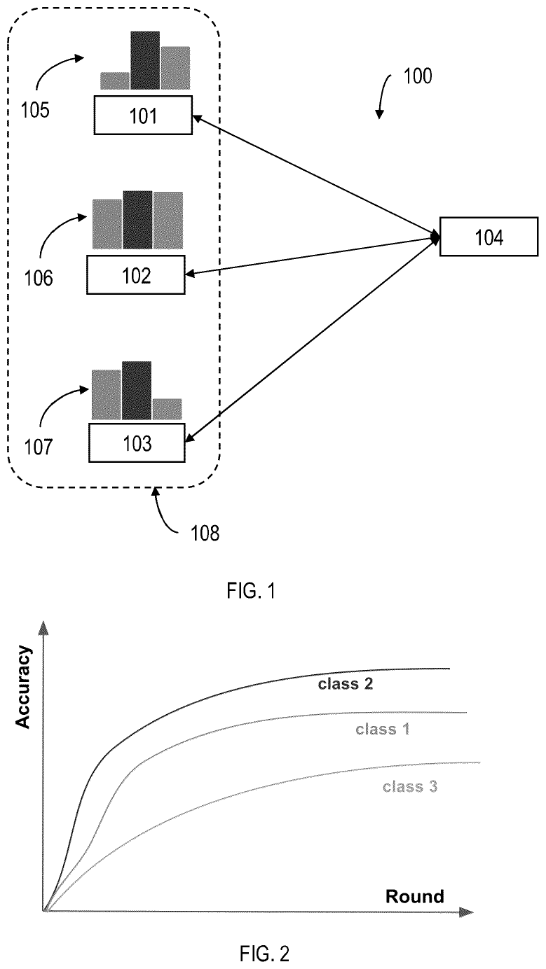

FIG. 1 shows a system 100 according to an example. The systems 100 comprises a set of client devices 108 and a server 104. The set of client devices 108 comprises at least one client device. A client device may also be referred to as a device or an apparatus. The server 104 may also be referred to as a second device or a second apparatus. Each device in the set of client devices 108 is communicatively coupled to the server 104. In the example of FIG. 1, the set of client devices 108 comprises a first client device 101, a second client device 102 and a third client device 103.

In an example, the system 100 of FIG. 1 is used for performing Federated Learning on a machine learning model. In the system 100 of FIG. 1 a machine learning model is maintained by the server 104 (also referred to as the parameter server). The machine learning model maintained by the server 104 may also be referred to as the global machine learning model.

The operation of the server 104 will be discussed in more detail below. However, in summary, the server 104 is configured to distribute (e.g. transmit) the machine learning model to client devices in the set of client devices 108 and receive model updates after the machine learning model has been trained locally by a client device in the set of client devices 108. The server 104 is further configured to update the machine learning model based on the received model updates to generate an updated machine learning model.

The operation of a client device (e.g. the first client device 101) in the set of client devices 108 will also be discussed in more detail below. However, in summary, the client device is configured to receive the machine learning model and optionally train the machine learning model using a local data set (e.g. a local training data set) associated with the client device. The client device is further configured to transmit the model updates to the server 104 after training.

In the system 100, the set of client devices 108 comprises the client devices that participate in the federated learning process. As will be discussed in more detail below, the examples described herein enable a client device in the set of client devices 108 to determine whether to participate in a specific training round of the federated learning process.

Federated learning has the advantage that a machine learning model can be trained to perform a particular function without compromising the security of the data used to train the model. This is because the data used to train the machine learning model is kept local to the client devices and is not shared with the server 104. Instead, only the model updates (e.g. updates to the parameters, such as weights or biases, of the machine learning model) are shared by the client device with the server 104.

In an example, the machine learning model is configured for classification. For example, the machine learning model is configured to predict a classification (e.g. a label) associated with data input into the machine learning model.

In an example the machine learning model is configured to determine if the input is associated with one of a plurality of classes. As known, a class is a category (or a label) associated with a data sample. In an example the plurality of classes comprises three classes: a first class, c₁, a second class, c₂, and a third class c₃. In the following description, reference will be made to an illustrative example where 3 classes are used. However, for the avoidance of any doubt it is emphasized that the plurality of classes can comprise any number of classes greater than 1 in other examples.

An example machine learning model is used for image classification (e.g. determining a classification/label associated with image data input into the machine learning model). In this example, an image may be associated with the class “Dog” if the image contains a representation of a dog. Similarly, the image may be associated with the class “Cat” if the image contains a representation of a cat.

In an example the machine learning model is configured to output information identifying which class from the plurality of classes is associated with the input data. In an example, the information comprises a probability that the input belongs to each of the plurality of classes (e.g. input data is 90% likely to be a dog, 10% to be a cat etc.). In another example, the information comprises the most-likely class from the plurality of classes.

In the system 100 of FIG. 1, the machine learning model is trained by client devices in the set of client devices 108 using local data sets that are associated with the client devices. In an example, each client device in the set of client devices 108 is associated with a local data set. In an example, the local data set associated with the client device is private (i.e., not known by other client devices in the set of client devices 108 and the server 104).

The local data set is used by the client device to train the machine learning model. The local data set used to train the machine learning model comprises examples of each of the plurality of classes. In this way, the machine learning model can be trained to recognise the plurality of classes in the input data.

In an example, the first client device 101 is associated with a first local data set 105. The first local data set 105 is a multi-class data set and comprises a plurality of data samples, each data sample associated with a class from the plurality of classes. The first local data set 105 is a multi-class data set because it comprises data samples for a plurality of classes.

In an example, the first local data set comprises the same classes of data as the machine learning model is configured to classify. In the specific example of FIG. 1, the first local data set 105 associated with the first client device 101 comprises three classes of data: the first class, c₁, the second class, c₂, and the third class c₃.

Each local data set is associated with a data distribution. The data distribution associated with a local data set indicates the proportion of data samples in that local data set that are associated with each class. In one example, the data distribution is expressed using percentages. In a specific example the first local data set 105 has a data distribution represented by c₁=10%, c₂=60%, c₃=30%. In this example: 10% of the data samples in the first local data set 105 are associated with the first class, c₁, 60% of the data samples in the first local data set 105 are associated with the second class, c₂, and 30% of the data samples in the first local data set 105 are associated with the third class, c₃.

In the example of FIG. 1, the second client device 102 is associated with a second local data set 106 and the third client device 103 is associated with a third local data set 107. The data sets at each client device have at least a common set of classes. In the example of FIG. 1, each of the first local data set 105, the second local data set 106 and the third local data set 107 comprise the same classes of data (e.g., the first class, c₁, the second class, c₂, and the third class, c₃).

In an example the data distribution of the first local data set 105 (associated with the first client device 101) is different to the data distribution of the second local data set 106 (associated with the second client device 102). In this way, the data sets associated with client devices in the set of client devices 108 are non-Independent or non-Identically Distributed (non-IID) data sets because the data distribution associated with the different client devices are not the same (e.g. the data is not Identically Distributed).

In one approach to Federated Learning, all of the client devices participate in training the machine learning model during each training round. Continually training a machine learning model at the client device like this can consume a lot of resources (e.g., processing resources and/or energy). As will be discussed in more detail below, the techniques described here can reduce the amount of resources (e.g. energy) required to train a machine learning model using Federated Learning. In the techniques described herein the client device determines whether to participate in a training round. In particular the client device determines whether training the machine learning model with the local data set available to the client device will change the performance of the received machine learning model. Based on this determination, the individual client devices determine if training the machine learning model with the local data set is a good use of the client device's resources.

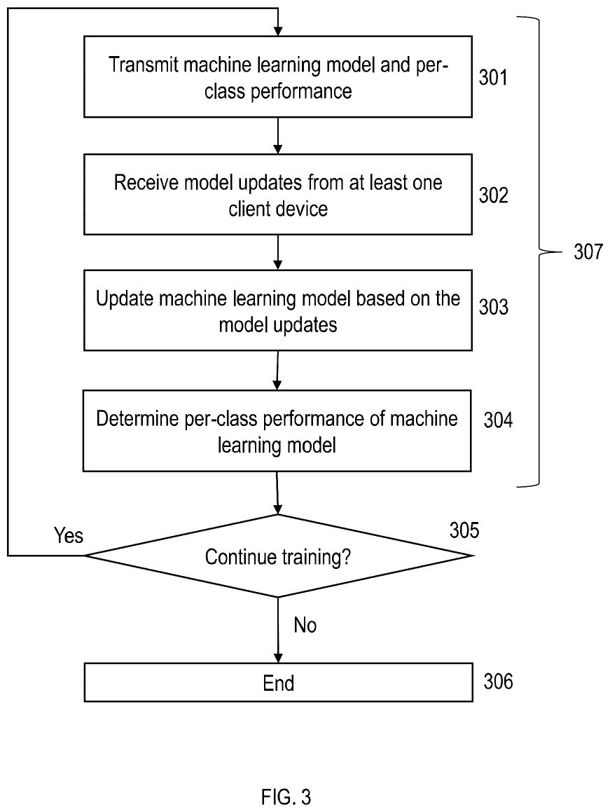

FIG. 2 shows a per-class accuracy during training according to an example. In particular, FIG. 2 shows a per-class accuracy during training for a client device where the data set used for training comprises more data samples associated with the second class than the first class and more data samples associated with the first class than the third class.

As can be seen in FIG. 2, as training progresses (i.e. as the training round increases) the accuracy of the second class improves fastest. It will be appreciated that this is possible because the training data set (which is used to train the machine learning model) has more data associated with the second class and so the machine learning model has more examples to train on. Similarly, at the start of training, the accuracy of the third class (which has the lowest proportion of data samples in this example) is the lowest and is the slowest to improve. FIG. 2 shows that the per-class accuracy of a machine learning model after training depends (at least in part) on the data distribution that the machine learning model was trained on.

In the techniques described below a client device determines whether training the machine learning model with the local data set available to the client device will change the performance of the machine learning model. If it is determined that the client device is associated with (e.g. has access to) data that can change the performance of the machine learning model, then the client device uses its resources (e.g., processing and/or energy resources) to train the machine learning model and contribute to the machine learning model. If, on the other hand, it is determined that the client device is not associated with (e.g. does not have access to) data that can change the performance of the machine learning model then the client device does not use its resources to locally train the machine learning model.

An example where the client device may determine that it cannot change the performance of the machine learning model is when the machine learning model (to be trained by the client device) already has the highest accuracy on a class associated with the highest proportion of data in the data set. In this case, using the resources of a client device to train the machine learning model on a data set that the machine learning model already performs well on would have limited returns and would have limited effect on the performance of the global machine learning model. By determining not to participate in the training round, the client device saves resources without significantly impacting the performance of the machine learning model being trained.

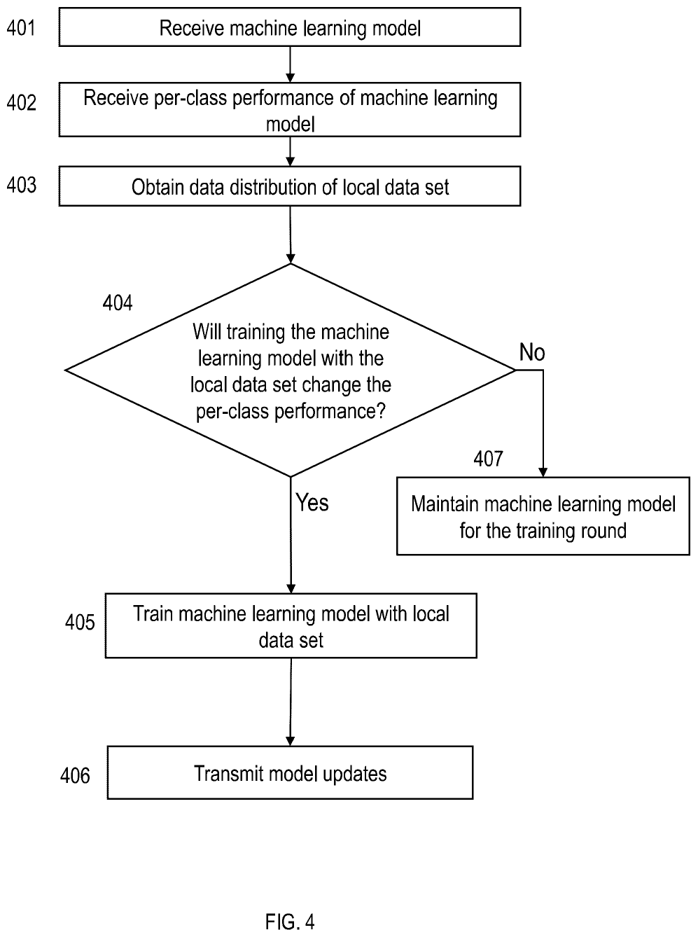

FIG. 3 shows a method performed by a server according to an example. In particular, FIG. 3 shows a method of training a machine learning model performed by the server 104. The method begins in step 301.

Step 301 comprises transmitting the machine learning model and the per-class performance of the machine learning model. In an example the server 104 transmits the machine learning model and the per-class performance to the set of client devices 108 (i.e. to each client device that is participating in the Federated Learning process).

In an example transmitting the machine learning model comprises transmitting information indicating the machine learning model (including one or more of: weights of the machine learning model, biases of the machine learning model, or layer structure of the machine learning model).

In an example the per-class performance comprises a performance metric indicating an ability of the machine learning model to correctly classify each class in the plurality of classes. An example performance metric includes an accuracy (e.g. the per-class accuracy). The per-class accuracy indicates the proportion (e.g. percentage) of times the machine learning model correctly classifies the data for each class. Another performance metric is a loss value. The method proceeds to step 302.

In step 302 the server 104 receives model updates from at least one client device in the set of client devices 108.

In an example, the model updates comprise updates (e.g. changes or revisions) to the parameters of the machine learning model after being locally trained by the at least one client device. In an example, the model updates comprise updated weights of the machine learning model after local training at the at least one client device. In another example, the model updates comprise the difference (i.e. the delta) between the weights of the transmitted machine learning model (transmitted in step 301) and the weights of the machine learning model after local training. In another example, the model updates comprise gradients of the machine learning model after local training by the at least one client device, wherein the gradients indicate the direction in which the parameters of the machine learning model at the server should be updated in (e.g. to minimize a loss function). In an example, model updates are received from a plurality of client devices in the set of client devices 108. In an example, step 302 further comprises determining the parameters of the machine learning model trained by the at least one client device (e.g. based on the model updates received in step 302) and storing the updated parameters of the machine learning model locally trained by the at least one client device. The method proceeds to step 303.

In step 303 the server 104 updates the machine learning model based (at least in part) on the model updates received in step 302.

As will be discussed in more detail below, the examples described herein enable each client device to determine whether or not to participate in a training round. Consequently, it is possible that in some training rounds the server 104 receives model updates from only a subset (i.e. not all) of the set of client devices 108.

In step 303 the server 104 updates the machine learning model based on the most recent parameters received from each client device in the set of client devices 108. The most recent parameters are the most-recently received parameters (i.e. the parameters of the machine learning model that were received, from the client device, closest (in time/training rounds) to the current training round).

For example, in the case that the first client device 101 decides to participate in the current training round, the parameters of the first client device's machine learning model will be based on the model updates received in step 302 (i.e. in the current training round, t). If, on the other hand, the first client device 101 decides not to participate in the current training round, the parameters of the first device's machine learning model used in step 303 are based on the model updates that were obtained in a previous training round (e.g. training round, t−1).

In an example the machine learning model is updated according to a model aggregation strategy. In an example, the model aggregation strategy comprises averaging the most-recent parameters received from each client device in the set of client devices 108 and modifying the parameters of the machine learning model with the averaged values. This aggregation strategy may also be referred to as average aggregation. In another example a different model aggregation strategy is used including, but not limited to: clipped average aggregation (where the model updates are clipped to a predefined range before being averaged), weighted aggregation (where the server 104 applies a weighting to the model updates from each client device), or adversarial aggregation (where outlier model updates are rejected before updating the machine learning model). In step 303 the machine learning model is updated to generate an updated version of the machine learning model. The method proceeds to step 304.

In step 304 the per-class performance of the machine learning model is determined. In particular the per-class performance of the updated version of the machine learning model is determined. As will be discussed in more detail below, there are provided different ways to determine the per-class performance of the machine learning model including, but not limited to: averaging per-class performance values received from each of the client devices in the set of client devices 108; and calculating the per-class performance at the server 104 using a test data set.

Steps 301, 302, 303 and 304 are performed in a training round 307. After determining the per-class performance of (the updated version of) the machine learning model, the method proceeds to step 305. In step 305 it is determined whether to continue training for another training round. In one example, step 305 comprises determining whether the number of training rounds performed by the server 104 is greater than or equal to a predetermined number of training rounds.

If, in step 305 it is determined to continue training then the method proceeds to step 306 where the method ends. If, on the other hand, it is determined to continue training in step 305, then the method proceeds to step 301 where the training round 307 begins again (this time transmitting the updated version of the machine learning model from the previous training round).

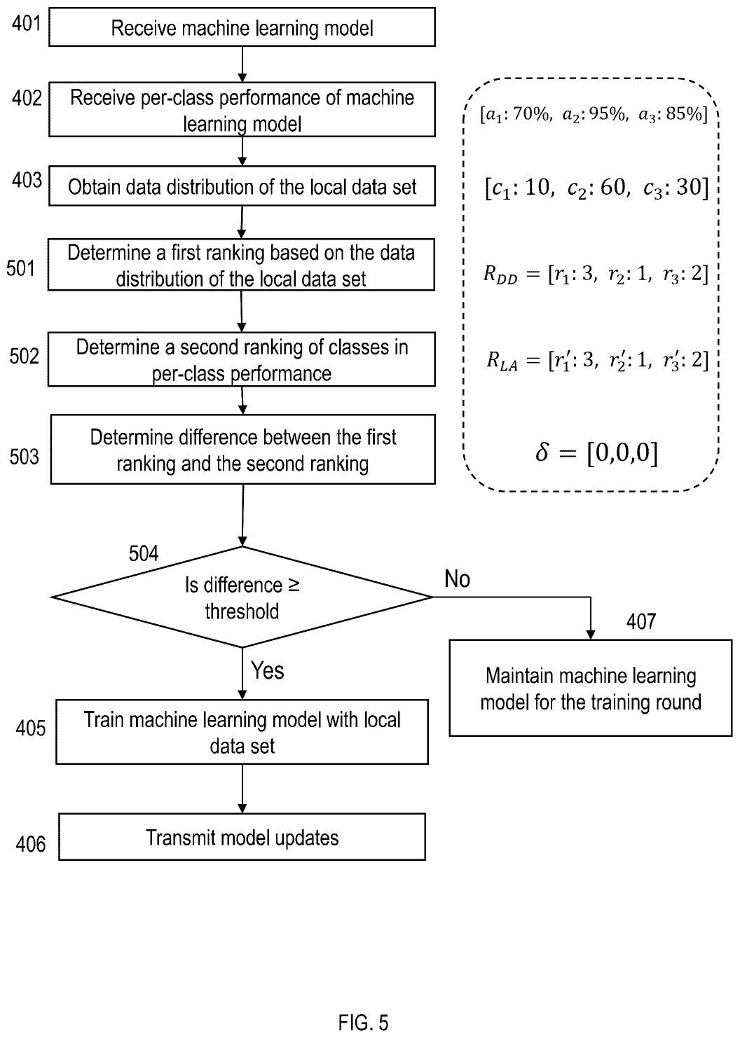

FIG. 4 shows a method performed by a client device according to an example. In an example the method of FIG. 4 is performed by a client device in the set of client devices 108. The method begins in step 401. In step 401 a machine learning model is received. In an example receiving the machine learning model comprises receiving information indicating the machine learning model (including one or more of: weights of the machine learning model, biases of the machine learning model, or layer structure of the machine learning model). The method proceeds to step 402.

In step 402 a per-class performance of the machine learning model is received. In an example the per-class performance received in step 402 indicates a performance of the machine learning model for correctly classifying each class in the plurality of classes. In an example, the per-class performance is a per-class accuracy. The method proceeds to step 403.

In step 403 the data distribution of the local data set is obtained. In an example where the method of FIG. 4 is performed by the first client device 101, the data distribution of the first local data set 105 is obtained (e.g. c₁=10%, c₂=60%, c₃=30%). The method proceeds to step 404.

In step 404 it is determined whether training the machine learning model with the local data set will change the per-class performance. In an example the determination is based on the data distribution of the local data set (obtained in step 403). In an example, it is determined whether training the machine learning model with the local data set will change the performance of a class relative to another class in the plurality of classes.

If it is determined that training the machine learning model with the local data set will not change the per-class performance of the machine learning model, then the method proceeds to step 407. In step 407 the machine learning model is maintained for the training round (i.e. the machine learning model is not trained by the client device implementing the method of FIG. 4). In an example step 407 comprises transmitting an indication to the server 104 that no training was performed by the client device. In another example, step 407 comprises transmitting information indicating the parameters of the machine learning model trained by the client device in a previous training round (i.e. before the current training round).

If, on the other hand, it is determined in step 404 that training the received machine learning model with the local data set will change the per-class performance of the machine learning model, then the method proceeds to step 405.

In step 405 the machine learning model (received in step 401) is trained using the local data set. Example approaches for training the machine learning model are discussed at the end of the description. In an example training the machine learning model comprises: generating a predicted classification using the machine learning model for a data sample in the local data set, determining a value of an objective function based on a difference between the predicted classification and a ground truth classification associated with the data sample, and updating parameters (e.g. weights) of the machine learning model based on the value of the objective function (e.g. with the aim of reducing the value of the objective function in future training rounds). After training the machine learning model in step 405, the method proceeds to step 406.

In step 406 the client device transmits model updates to the server 104. In an example the model updates comprise at least one of: the parameters (e.g. weights) of the machine learning model after training in step 405 or the difference between the parameters of the machine learning model obtained in step 401 and the parameters after training in step 405.

In an example, steps 401 to 406 are performed at the client device during one (i.e. a single) training round.

In the method of FIG. 4, it is determined whether training the machine learning model with the local data is likely to change the performance of the machine learning model. If training with the local data set is unlikely to change the performance of the machine learning model then the client device (e.g. the first client device 101) saves its resources (e.g. energy and/or computing resources) and does not locally train the machine learning model for this training round. In this case the client device has made a determination that training with the local set data will not influence (e.g. change) the performance of the machine learning model and so it is not an effective use of the client device's resources. If on the other hand, the client device determines that it has access to a local data set that can change the performance of the received machine learning model, then the client device uses its resources to locally train the machine learning model and influence the performance of global machine learning model at the server 104. This approach is particularly useful where the client devices have non-Independent and non-Identically Distributed (non-IID) data sets because in this case, each client device may have access to different amounts of data for each class.

The method of FIG. 4, enables a client device to determine whether to participate in the training round (before starting the training round) based on whether the client device has access to data that will change the performance of the machine learning model. Hence, the method of FIG. 4, enables selective participation in machine learning model training in a way that effectively uses device resources. In an example, the method of FIG. 4, reduces energy consumption when the act of training a machine learning model is (at least partly) delegated to a client device by a server (e.g. in Federated Learning).

In a specific example, in a first training round, the per-class performance of the machine learning model may not be available. In this case the machine learning model is trained in the first round (e.g. following steps 401, 405 and 406) before the method of FIG. 4 is used for subsequent training rounds. In other examples, the complete method of FIG. 4 is performed in the first training round (e.g. where the per-class performance is available in the first training round).

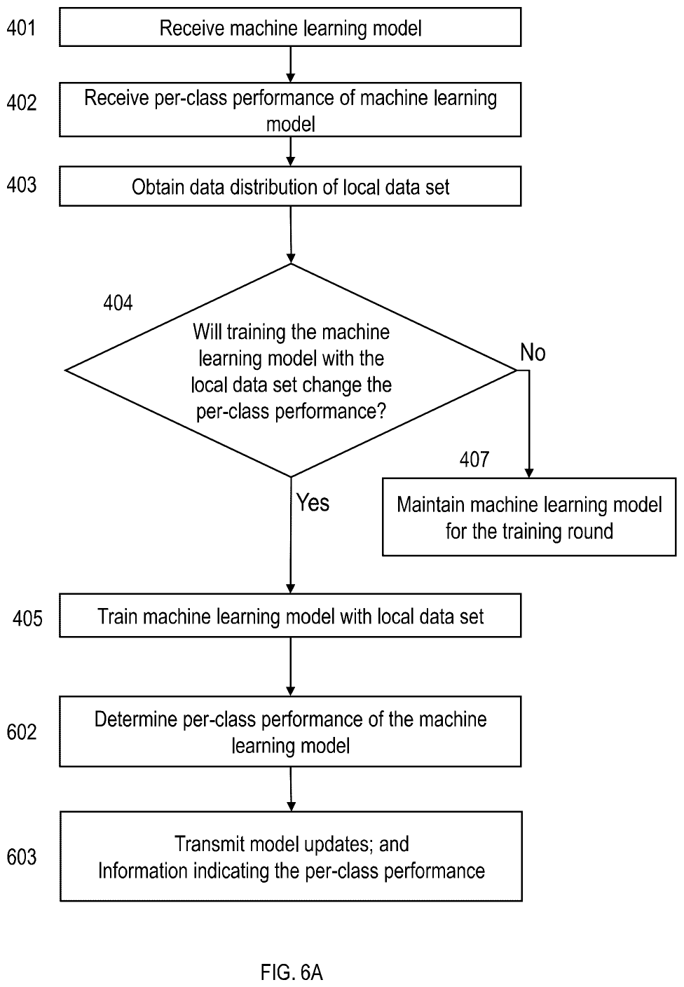

FIG. 5 shows a method performed by the client device according to a second example. The method of FIG. 5 is a specific implementation of the method of FIG. 4. As will be apparent from the description below, the method of FIG. 5, provides a specific example of how to determine if training the machine learning model with the local training set will change the performance of the machine learning model. In FIG. 5, same reference numerals as FIG. 4 are used to denote same functionality.

The method begins in step 401 by receiving the machine learning model and proceeds to step 402. In step 402 the per-class performance of the machine learning model is received. In the specific example of FIG. 5 the per-class performance is a per-class accuracy.

In the illustrative example of FIG. 5, the per-class accuracy received in step 402 indicates that: the accuracy for the machine learning model predicting the first class (i.e. a₁) is 70%; the accuracy for the machine learning model predicting the second class (i.e. a₂) is 95%; and the accuracy for the machine learning model predicting the third class (i.e. a₃) is 85%. In FIG. 5, the per-class accuracy obtained in step 402 is represented as [a₁:70%, a₂:95%, a₃:85%]. The method proceeds to step 403.

In step 403 the data distribution of the local data set is obtained. In the illustrative example of FIG. 5, the local data set is the first local data set 105 (associated with the first client device 101). In this example, the data distribution is represented by: c₁=10%, c₂₌₆₀%, c₃=30%; where 10% of the data samples in the first local data set 105 are associated with the first class, c₁, 60% of the data samples in the first local data set 105 are associated with the second class, c₂, and 30% of the data samples in the first local data set 105 are associated with the third class, c₃. After obtaining the data distribution of the local data set in step 403, the method proceeds to step 501.

Step 501 comprises determining a first ranking, R_{DD}, of the plurality of classes based on the data distribution of the local data set. In an example, the first ranking comprises a rank (i.e. a position in a hierarchy) of each class in the plurality of classes based on the proportion of data samples of each class in the local data set. In an example, the rank of each class in the first ranking is the position of each class in an ordered list, when the classes are sorted in order of decreasing proportion of data samples in the local data set (i.e., class with highest proportion of data samples in the local data set is position 1 in the ordered list).

For example, in the illustrative example of FIG. 5, the second class, c₂, has the largest proportion/number of data samples in the local data set (60%), so the second class is associated with ranking 1 (i.e. r₂=1). Similarly, the third class, c₃, has the 2^{nd} highest proportion/number of data samples in the local data set (30%), so the third class is associated with ranking 2 (i.e. r₃=2). Likewise, the first class, c₁, has the 3^{rd} highest proportion/number of data samples in the local data set (10%) so the third class is associated with ranking 3 (i.e. r₁=3). The method proceeds to step 502 after determining the ranking of classes in the data distribution of the local data set.

Step 502 comprises determining a second ranking, R_{L}A, based on the per-class performance of the machine learning model. In an example the second ranking comprises a rank (i.e. a position in a hierarchy) of each class in the plurality of classes based on the per-class performance metric. In an example, the rank of each class in the second ranking is the position of each class in an ordered list, when the classes are sorted in order of decreasing performance metric (i.e., highest performance is position 1 in the ordered list).

For example, in the illustrative example of FIG. 5, the second class, c₂, has the highest accuracy (95%), so the second class is associated with ranking 1 (i.e. r₂′=1). Similarly, the third class, c₃, has the 2^{nd} highest accuracy (85%), so the third class is associated with ranking 2 (i.e. r₃′=2). Likewise, the first class, class, c₁, has the 3^{rd} highest accuracy (70%) so the third class is associated with ranking 3 (i.e. r₁′=3). The method proceeds to step 503.

In step 503 the difference between the first ranking (obtained in step 501) and the second ranking (obtained in step 502) for each respective class is obtained. In an example, the difference is the absolute difference (i.e. the magnitude of the difference, ignoring a direction of the difference).

In an example, the difference between the first ranking and the second ranking is obtained by determining the absolute value (i.e. the magnitude) of a difference between a ranking of a class in the first ranking and a ranking of the (same) class in the second ranking (e.g. r₁−r₁′).

It will be appreciated that where the first ranking, R_{DD}, and the second ranking, R_{L}A, are represented as matrices, where the column number corresponds to the class number and the element in each column corresponds to the rank (e.g. as illustrated in FIG. 5), then the difference is calculated according to the absolute value of the second ranking, R_{L}A, (element-wise) subtracted from the first ranking, R_{DD}.

In the illustrative example of FIG. 5, the second ranking, R_{DD}, is represented by the matrix: [3, 1, 2] and the first ranking, R_{L}A, is represented by the matrix: [3, 1, 2]. In this case the difference is: abs([3−3, 1−1, 2−2])=[0, 0, 0]; where abs( ) is the absolute value or modulus. The method proceeds to step 504.

In step 504 it is determined whether the difference is greater than or equal to a predetermined difference threshold.

In an example, step 504 comprises summing the differences between the first ranking and the second ranking for each class (e.g. 0+0+0 in the example of FIG. 5) and determining if the sum of the ranking differences is greater than or equal to the predetermined difference threshold. In an example the predetermined threshold is an integer (e.g. 3). It will be appreciated that other techniques to determine whether the difference is greater than the predetermined difference threshold can be used in other examples.

The method proceeds to step 407 if it is determined in step 504 that the difference is less than the predetermined difference threshold. In the illustrative example of FIG. 5, the sum of the difference values (e.g. 0) is less than the predetermined difference threshold (e.g. 3) so the method proceeds to step 407. As discussed above in relation to FIG. 4, in step 407 the machine learning model is maintained (i.e. not trained) by the client device in this training round. In this case it has been determined that the data distribution of the local data set will not change the per-class performance. In this case the client device does not use its resources (e.g. processing and/or energy resources) to train the machine learning model since local training will not substantially influence (e.g. change) the performance of the machine learning model.

In contrast, the method proceeds to step 405 if it is determined that the difference is greater than or equal to the predetermined difference threshold. As discussed above in relation to FIG. 4, in step 405 the machine learning model is trained with the local data set. After step 405, the method proceeds to step 406 where model updates are transmitted (e.g. to the server 104). In this case it has been determined that training the machine learning model with the local data set will likely influence (e.g. change) the performance of the machine learning model, so it is an efficient use of the client device's resources to train the machine learning model with the local data.

In an example, the method of FIG. 5 is repeated each training round during a federated learning process (comprising a plurality of training rounds). It will be appreciated that steps 501, 502, 503 and 504 are one example implementation of step 404 in FIG. 4.

An additional illustrative example is also provided for understanding. In this additional illustrative example the per-class performance of the machine learning model (received in step 402) is represented by: [a₁: 70%, a₂:95%, a₃: 85%], the data distribution of the local data set (obtained in step 403) is represented by: [c₁: 40, c₂: 10, c₃: 50], the first ranking based on the data distribution (determined in step 501) is represented by: [r₁: 2, r₂: 3, r₃: 1] and the second ranking based on the per-class performance (determined in step 502) is represented by: R_{LA}=[r₁′: 3, r₂: 1, r₃: 2]. In this illustrative example the difference (determined in step 503) is represented by: 6=[1, 2, 1]. In this example, the machine learning model is retrained using the local data set since the sum of the difference in rankings for each class (i.e. 1+2+1=4) is greater than or equal to the predetermined difference threshold required for local training (i.e. 3).

Various approaches for determining the per-class performance of the machine learning model (i.e. step 304 of FIG. 3) will now be discussed.

In an example the client device determines a per-class performance of the machine learning model after training the machine learning model on the local data set and transmits information indicating the per-class performance to the server 104. The server 104 subsequently determines the per-class performance of the updated machine learning model by aggregating (e.g. averaging) the per-class performances received from the client devices.

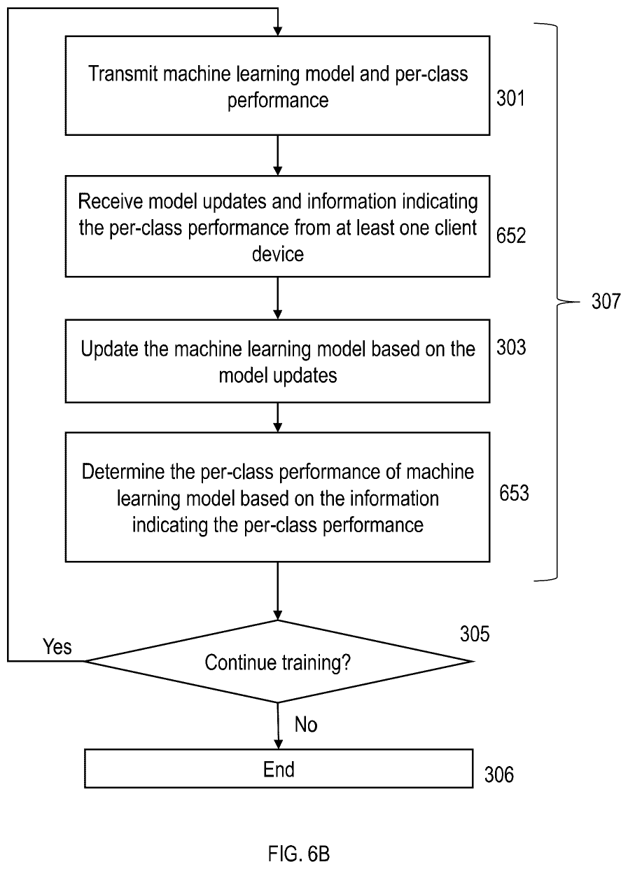

FIG. 6A shows a first variant of a method performed by the client device according to an example. In particular, FIG. 6A shows a first variant of the method of FIG. 4. As will become apparent from the description below, in the first variant the per-class performance of the machine learning model updated by the server 104 is based on performance metrics determined by the client devices. FIG. 6A uses same reference numerals as FIG. 4 to denote same functionality. Reference is made to the description of FIG. 4 for discussion of steps 401, 402, 403, 404, and 407. It will be appreciated that step 404 can be implemented as described in relation to FIG. 5.

If, in step 404, it is determined that training the machine learning model with the local data set will change the per-class performance, then the method proceeds to step 405. In step 405 the machine learning model is trained with the local data set. The method proceeds to step 602.

In step 602 the per-class performance of the machine learning model after local training (i.e. after completing step 405) is determined. In an example, the per-class performance of the locally trained machine learning model is referred to as an updated per-class performance. In an example, the updated per-class performance is determined using the local data set. In an example, the local data set comprises a training data set and a test data set. The training data set is used in step 405 to train the machine learning model and the test data set is used in step 602 to determine the per-class performance of the machine learning model after local training.

In an example step 602 comprises determining the per-class accuracy (i.e. the classification accuracy for each class) of the machine learning model. After determining the per-class performance the method proceeds to step 603.

In step 603 the model updates (e.g. the weights of the updated machine learning model, or the update differences/deltas) and information indicating the per-class performance are transmitted (e.g. to the server 104). In an example, the information indicating the per-class performance comprises at least one of: the per-class performance; or an obscured per-class performance (i.e. an obscured version of the per-class performance).

FIG. 6B shows a first variant of a method performed by the server according to an example. In an example, the method of FIG. 6B is performed by the server 104. The method of FIG. 6B is a specific implementation of the method of FIG. 3 and uses the same reference numbers as FIG. 3 to denote same features.

For ease of explanation, FIG. 6B will be discussed starting from step 652. In step 652 the model updates and information indicating the per-class performance of the (locally-trained) machine learning model (represented by the model updates) are received from at least one client device in the set of client devices 108.

The method proceeds to step 303 where the machine learning model is updated based on the model updated. The machine learning model is updated to generate an updated version of the machine learning model. In an example, step 652 comprises storing the model updates and information indicating the per-class performance received from the at least one client device such that there is a record of the most-recently received model updates and per-class performance associated with each client device. As will be discussed in more detail below, this is used where a client device does not participate in the training round. In this case, the most recently-received model updates and per-class performance values will be used. The method proceeds to step 653.

In step 653 the per-class performance of the updated version of the machine learning model is determined based on the information indicating the per-class performance received from the at least one client device. In an example, the per-class performance of the machine learning model is determined by averaging the values of the (most-recently received) information indicating the per-class performances received from the client devices in the set of client devices 108.

The method proceeds to step 305. If it is determined in step 305 to continue training, then the method proceeds to step 301 where the training round 307 begins again.

In step 301 the machine learning model (updated in step 303) and the per-class performance of the machine learning model (determined in step 653) is transmitted (e.g. to each client device in the set of client devices 108).

In a first example of the first variant, the information indicating the per-class performance of the locally trained machine learning model (transmitted by the client device in step 603 of FIG. 6A) comprises the per-class performance. In this example, the per-class performance is communicated without changing the value of the per-class performance.

In the first example, determining the per-class performance (i.e. step 653 of FIG. 6B) comprises: averaging the most-recently received per-class performance for each client device in the set of client devices 108. In the case where the client device decided to participate in the training round, then the most recently received per-class performance for the client device will be the per-class performance received in step 652. In the case where the client device did not participate in the training round (and therefore no model updates or per-class performance information was received in step 652 of the current training round) the last received per-class performance metric from that client device is used.

In an example, the per-class performance for the updated version of the machine learning model is determining according to:

$${a}_{1 \_ updated} = \frac{1}{N} {\sum }_{k = 1}^{N} {a}_{1}^{k}$$

### Where:

a_{1_updated} is the performance of the updated version of the machine learning model for a first class, c₁;
N is the number of client devices in the set of client devices 108 (i.e. that are participating in the Federated Learning process); and
a₁^{k} is the most-recently reported performance, by client device k, of the locally trained machine learning model, for classifying the first class, c₁. In the case where client device k does not participate in the current training round, the performance for first class will be the performance received in a previous training round.

In an example, the above calculation is repeated for each class in the plurality of classes (e.g. the second class, c₂, and the third class, c₃).

In the first example of the first variant, the client device transmits the per-class performance un-modified. It is possible in some situations for the server 104 (or a third party) to infer the data distribution at the client device based on the communicated per-class performance values since it likely that the locally trained machine learning model will perform best on the class of data that the client device has the most examples of in the local data set.

In an example, the information indicating the per-class performance transmitted by the client device comprises an obscured version of the per-class performance. As will be appreciated from the description below, transmitting an obscured version of the per-class performance improves data privacy since it is more difficult for the server 104 (or the third party) to determine the data distribution of the local data set, thereby preserving client privacy.

In a second example of the first variant step 602 of FIG. 6A (determining the per-class performance of the machine learning model) further comprises obscuring the per-class performance after determining the per-class performance to obtain an obscured version of the per-class performance. In an example the obscured version of the per-class performance is determined by modifying the values of the per-class performance such that the values of the per-class performance are concealed (or obfuscated).

A first technique for obscuring the per-class performance comprises modifying the per-class performance with randomly generated noise. For example, by adding a random noise value to the performance metric of each class in the per-class performance. In an example the random noise value is generated by sampling from a probability density function (e.g. a normal distribution) having a mean of zero.

In this technique, the information indicating the per-class performance transmitted by a client device comprises the obscured version of the per-class performance (i.e. the combination of the per-class performance and randomly generated noise).

As discussed above in relation to FIG. 6B, in step 652 the sever 104 receives information indicating the per-class performance from at least one client device (e.g. each client device that participates in the training round 307). When the first technique for obscuring the per-class performance is used by the client devices, step 652 comprises receiving the obscured version of the per-class performance. In particular, step 652 comprises receiving a noisy version of the per-class performance (i.e. the per-class performance modified using random noise) from each client device that participates in the training round 307.

In step 653 of FIG. 6B, the server 104 determines the per-class performance of the updated machine learning model by averaging the obscured versions of the per-class performances received from the client devices. As will be appreciated, averaging the noisy per-class performance values will remove the effect of the randomly generated noise. Consequently, the per-class performance of the updated machine learning model determined by the server 104 will be accurate (i.e. the noise will not substantially affect the performance calculation), however the privacy of the local data sets will be maintained (since the per-class performance, which can be used to infer the data distribution of the local data set, is obscured outside the client device).

A second technique for obscuring the per-class performance comprises using homomorphic encryption. Homomorphic encryption is a form of encryption that allows computations to be performed on encrypted data without first having to decrypt the data.

Various homomorphic encryption schemes are known. In an example the homomorphic encryption scheme comprises at least one of: Brakerski-Gentry-Vaikuntanathan (BGV), Brakerski/Fan-Vercauteren (BFV), or Cheon-Kim-Kim-Song (CKKS) encryption schemes. In other examples any homomorphic encryption scheme can be used provided it is additively and multiplicatively homomorphic (i.e. can perform both addition and multiplication in the encrypted domain).

A specific implementation of the second technique will now be discussed. However, it will be appreciated that other implementations are used in other examples.

In the second technique for obscuring the per-class performance (e.g. by using homomorphic encryption) each client device in the set of client devices 108 obtains a private encryption key. In an example the private encryption key is a homomorphic encryption key (i.e. a private encryption key generated in accordance with a homomorphic encryption scheme). In an example each client device obtains the same private encryption key. In an example the private encryption key is obtained from a third party (e.g. from a key server).

In the second technique the server 104 also obtains a public encryption key. In an example the public encryption key is a homomorphic encryption key (i.e. a public encryption key generated in accordance with a homomorphic encryption scheme). In an example the server 104 obtains the public encryption key from a third party (e.g. from the key server).

The method performed by the client device (i.e. FIG. 6A) will now be discussed. In an example, step 602 comprises determining the per-class performance of the machine learning model in plain-text (i.e. unencrypted or un-obscured). In the second technique, step 602 further comprises obscuring the per-class performance of the machine learning model using homomorphic encryption. In an example, step 602 further comprises encrypting the determined (plain-text) per-class performance with the private encryption key to obtain an encrypted per-class performance (i.e. an encrypted version of the per-class performance). The method proceeds to step 603. In step 603 the information indicating the per-class performance comprises the encrypted version of the per-class performance.

Referring to FIG. 6B, step 652 comprises receiving information indicating the per-class performance from at least one client device (e.g. from each device that participates in the training round 307). In the second technique the information indicating the per-class performance comprises the encrypted per-class performance. The method proceeds to step 303 and then step 653.

In step 653 the per-class performance of the updated machine learning model is determined based on the encrypted per-class performance received from the client devices. In an example, the per-class performance of the updated machine learning model is determined based on the encrypted per-class performance received from the at least one client device. In an example, the per-class performance is determined by averaging the encrypted per-class performance received from the client devices. The per-class performance of the updated machine learning model (determined in step 653) in the second technique is obscured (i.e. not the plain-text value). Therefore, the per-class performance determined in step 653 is an obscured version of the per-class performance. The method proceeds to step 301 if it is determined to continue training in step 305.

In the second technique for obscuring the per-class performance, step 301 comprises transmitting the obscured version of the per-class performance to at least one client device.

Returning to the method of FIG. 6A. In the second technique, at the start of a training round, step 402 comprises receiving the obscured version of the per-class performance and decrypting the obscured per-class performance to obtain the per-class performance of the machine learning model. In an example, the obscured per-class performance is decrypted using the private encryption key obtained by the client device.

In the second technique the per-class performance of the machine learning model trained by each client device is obscured using encryption. Consequently, it is more difficult for the server 104 (or a third party) to obtain information about the data distribution of the local data set that is private to each client device, thereby improving privacy.

In the first variant the server 104 determines the performance of the updated machine learning model based on the performance metrics generated locally by each client device. In this way, the performance of the updated machine learning model is based on the local data sets accessible to each respective client device.

In another example, the per-class performance of the updated machine learning model is determined by the server 104 using a data set known to the server 104. It will be appreciated that in this approach the client device (that trains the machine learning model based on its local (private) data set) does not need to determine and transmit the per-class performance of the updated model.

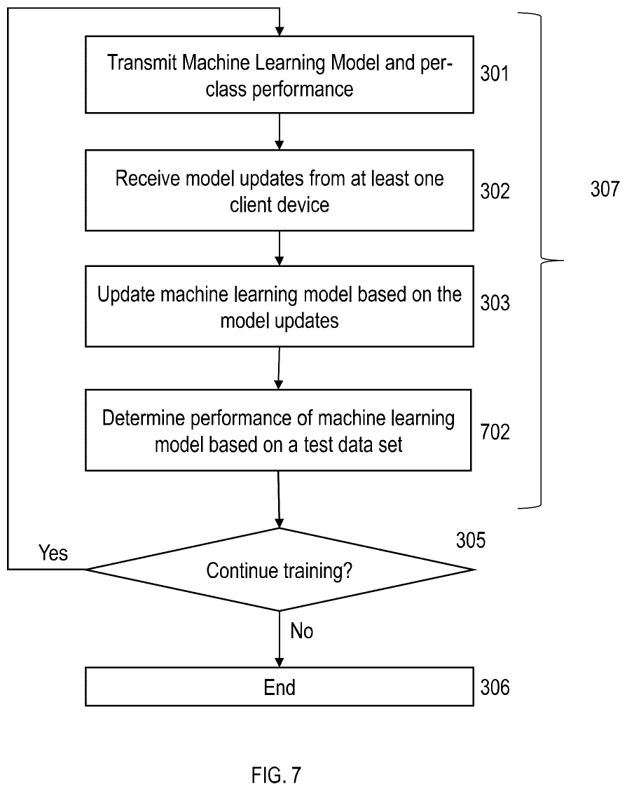

FIG. 7 shows a second variant of a method performed by the server according to an example. In particular, FIG. 7 shows a second variant of the method of FIG. 3. FIG. 7 uses same reference numerals as FIG. 3 to denote same functionality. The method of FIG. 7 will be discussed starting from step 303 of the training round 307. In step 303 the machine learning model is updated based on the model updates received from the at least one client device in step 302. The method proceeds to step 702 after updating the machine learning model in step 303.

Step 702 comprises determining the per-class performance of the machine learning model based on a test data set. In an example the performance is the accuracy. In an example, determining the per-class accuracy of the machine learning model based on the test data set comprises classifying data samples from the test data set using the updated machine learning model and comparing a predicted classification with a ground truth classification included in the test data set to determine an accuracy with which the updated machine learning model correctly predicts a classification. In an example the server 104 comprises the test data set.

The method proceeds to step 301 if it is determined in step 305 to continue training. Step 301 comprises transmitting the machine learning model and the per-class performance of the machine learning model. In the example of FIG. 7, the per-class performance transmitted in step 301 if the per-class performance for the machine learning model determined in step 702 of a previous training round.

In the second variant, the client device performs the method of FIG. 4 (and optionally FIG. 5).

The examples described above enable efficient use of resources (e.g. processing and/or energy resources) in a distributed computing system. In particular, the examples described above enable client devices to determine whether their participation in a Federated Learning training round will affect the global machine learning model. Enabling client devices to make this determination before consuming resources improves the resource efficiency of a distributed computed system.

The examples described herein can be used in many specific technical fields.

A first use-case is image recognition. In the first use-case the machine learning model is configured to receive image data at an input of the machine learning model and output a classification/label for the image data (e.g. indicating a label/class of an object in the image). In the first use-case the local data set (e.g. associated with the first client device 101) comprises image data.

A second use-case is industrial monitoring. In the second use-case the machine learning model is configured to receive process or product inspection information at an input of the machine learning model and output a classification/label indicating a status of the industrial process or product being monitored. In the second use-case the local data set (e.g. associated with the first client device 101) comprises process or product inspection information.

A third use-case is voice recognition. In the third use-case the machine learning model is configured to receive voice utterances (e.g. audio data) at an input of the machine learning model and output a classification/label for the voice utterances. In the third use-case the local data set (e.g. associated with the first client device 101) comprises audio data associated with a user.

A fourth use-case is health monitoring. In the fourth use-case the machine learning model is configured to receive sensor data at an input of the machine learning model and output a classification/label indicating a medical condition. In an example the sensor data comprises activity data such as locomotive or motion signatures from inertial sensors carried on, or embedded in, resource-limited body-worn wearables such as smart bands, smart hearing aids and/or smart rings. In an example the medical condition comprises: dementia or early stage cognitive impairment. In the fourth use-case the local data set (e.g. associated with the first client device 101) comprises private sensor data associated with a specific user.

In the description above, reference is made to a machine learning model. The techniques described herein are not limited in their application to a specific machine learning model architecture. In an example the machine learning model comprises at least one of: an artificial neural network, decision trees, or support vector machines.

In an example the machine learning model comprises a convolutional (artificial) neural network. In another example the machine learning model comprises a fully connected (artificial) neural network.

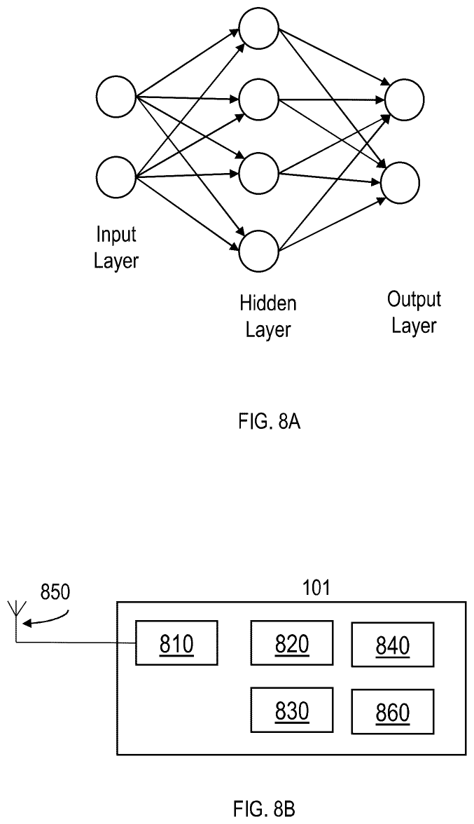

FIG. 8A shows an illustration of a fully connected (artificial) neural network according to an example. In particular, FIG. 8A shows an (artificial) neural network comprising an input layer, a hidden layer and an output layer. In the example of FIG. 8A, the input layer comprises two neurons (or nodes), the hidden layer comprises four neurons and the output layer comprises two neuron. Although one example implementation is shown in FIG. 8A, it will be appreciated that other implementations may use a different number of neurons per layer and a different number of hidden layers. In the (artificial) neural network the output from each neuron is: a weighted sum of the inputs to the neuron, that is subsequently passed through an activation function (e.g. Sigmoid, ReLu, Tanh etc.). The weights of the weighted sum are trainable and are referred to throughout the description as weights (or parameters more generally). By training the weights of the machine learning model it is possible to implement a transform that maps a set of inputs to a specific set of outputs (e.g. that classifies the input data into one of plurality of classes).

In the description above, reference is made to the step of training the machine learning model (e.g. in step 405 of FIG. 4). Various approaches for training the machine learning model can be used.

In an example, the machine learning model is trained using a supervised learning technique. In an example step 405 of FIG. 4 (i.e. training the machine learning model using a local data set) comprises inputting a data sample from the local data set into the machine learning model, obtaining an output from the machine learning model for the data sample, determining a value of an objective function based on a difference between a predicted classification (i.e. the output of the machine learning model) and a ground truth classification for the data sample. In an example the local data set comprises the data sample and the ground truth classification. In an example, training the machine learning model further comprises updating the parameters (e.g. at least one of: weights or biases) of the machine learning model based on the value of the objective function (e.g. to increase or decrease the value of the objective function).

In an example the weights of the machine learning model are updated using backpropagation (i.e. backpropagation of errors). As known in the art, in this technique a partial derivate of the objective function with respect to each trainable weight is calculated. These partial derivatives are subsequently used to update the value of each trainable weight.

In an example where the aim is to reduce a value of the objective function, the trainable weights of the machine learning model are updated using gradient decent such that:

$${w}^{( i , j )} = {w}^{( i , j )} - α \frac{dJ}{\partial {w}^{( i , j )}}$$

where:
w^{(i,j)} is the trainable weight for the i^{th} neuron in the j^{th} layer;
α is the learning rate. Optionally, the learning rate is predetermined; and
is the partial derivative of the objective function, J, with respect to the trainable weight w^{(i,j)}.

In an example the artial derivate of the objective function, J, with respect to the trainable weight w^{(i,j)}

$$\frac{dJ}{\partial {w}^{( i , j )}}$$

is determining using calculus (including using the chain rule) based

$$( i . e . \frac{dJ}{\partial {w}^{( i , j )}} )$$

on the structure of the machine learning model (e.g. based on the connection of the layers, the activation functions used by each neuron etc.). Various different objective functions, J, can be used to train the machine learning model including but not limited to: Maximum Likelihood Estimation, or Cross Entropy.

FIG. 8B shows an implementation of the first client device 101 according to an example. The first client device 101 comprises an input/output module 810, a processor 820, a non-volatile memory 830 and a volatile memory 840 (e.g. a RAM). The input/output module 810 is communicatively connected to an antenna 850. The antenna 850 is configured to receive wireless signals from, and transmit wireless signals to, other devices including the server 104. The processor 820 is coupled to the input/output module 810, the non-volatile memory 830 and the volatile memory 840.

The non-volatile memory 830 stores computer program instructions that, when executed by the processor 820, cause the processor 820 to execute program steps that implement the functionality of a first client device 101 as described in the above-methods. In an example, the computer program instructions are transferred from the non-volatile memory 830 to the volatile memory 840 prior to being executed. Optionally, the first client device 101 also comprises a display 860.

In an example, the non-transitory memory (e.g. the non-volatile memory 830 and/or the volatile memory 840) comprises computer program instructions that, when executed by the processor 820, perform the methods described above. In an example, the non-transitory memory (e.g. the non-volatile memory 830 and/or the volatile memory 840) comprises computer program instructions that, when executed by the processor 820, cause the processor 820 to perform the methods of at least one of: FIG. 4, FIG. 5, or FIG. 6A described above.

Whilst in the example described above the antenna 850 is shown to be situated outside of, but connected to, the first client device 101 it will be appreciated that in other examples the antenna 850 forms part of the first client device 101.

In an example the server 104 comprises the same components (e.g. an input/output module 810, a processor 820, a non-volatile memory 830 and a volatile memory 840 (e.g. a RAM)) as the first client device 101. In this example, the non-volatile memory 830 stores computer program instructions that, when executed by the processor 820, cause the processor 820 to execute program steps that implement the functionality of a server 104 as described in the above-methods. In an example, the non-transitory memory (e.g. the non-volatile memory 830 and/or the volatile memory 840) comprises computer program instructions that, when executed by the processor 820, cause the processor 820 to perform the methods of at least one of: FIG. 3, FIG. 6B, or FIG. 7 described above.

The term “non-transitory” as used herein, is a limitation of the medium itself (i.e., tangible, not a signal) as opposed to a limitation on data storage persistency (e.g., RAM vs. ROM).

As used herein, “at least one of the following: <a list of two or more elements>” and “at least one of: <a list of two or more elements>” and similar wording, where the list of two or more elements are joined by “and” or “or”, mean at least any one of the elements, or at least any two or more of the elements, or at least all the elements.

While certain arrangements have been described, the arrangements have been presented by way of example only and are not intended to limit the scope of protection. The concepts described herein may be implemented in a variety of other forms. In addition, various omissions, substitutions and changes to the specific implementations described herein may be made without departing from the scope of protection defined in the following claims.

1.-15. (canceled)

16. Apparatus comprising:
at least one processor; and
at least one memory storing instructions that, when executed by the at least one processor, cause the apparatus at least to:
receive a machine learning model, wherein the machine learning model is caused to classify input data into a plurality of classes;
receive a per-class performance of the machine learning model;
obtain a data distribution of a local data set;
determine, based on the data distribution of the local data set, if a training of the machine learning model with the local data set will change the per-class performance of the machine learning model; and
in response to the determining that the training of the machine learning model with the local data set will change the per-class performance of the machine learning model:
train the machine learning model using the local data set.

17. The apparatus according to claim 16, further caused to:
transmit model updates after the training of the machine learning model.

18. The apparatus according to claim 16, wherein the determining if the training of the machine learning model with the local data set will change the per-class performance of the machine learning model further comprises:
compare the data distribution of the local data set and the per-class performance of the machine learning model.

19. The apparatus according to claim 18, wherein the comparing of the data distribution of the local data set and the per-class performance of the machine learning model further comprises:
determine a first ranking for the plurality of classes based on the data distribution of the local data set;
determine a second ranking for the plurality of classes based on the per-class performance;
determine a difference between the first ranking and the second ranking; and
determine that training the machine learning model with the local data set will change the per-class performance of the machine learning model in response to determining that the difference is greater than a first threshold.

20. The apparatus according to claim 19, wherein:
the per-class performance comprises information indicating a performance of the machine learning model for classifying a first class in the plurality of classes; and
the data distribution of the local data set comprises information indicating a proportion of the local data set associated with the first class in the plurality of classes.

21. The apparatus according to claim 20, wherein:
the determining of the first ranking for the plurality of classes based on the per-class performance further comprises:
rank the first class in the plurality of classes based on the performance of the machine learning model for classifying the first class; and
determine the second ranking for the plurality of classes based on the data distribution of the local data set further comprises:
rank the first class in the plurality of classes based on the proportion of the local data set associated with the first class.

22. The apparatus according to claim 16, further caused to:
determine an updated per-class performance of the machine learning model after training the machine learning model; and
transmit information indicating the updated per-class performance.

23. The apparatus according to claim 22, wherein the transmitting of information indicating the updated per-class performance further comprises:
generate an obscured per-class performance based on the updated per-class performance; and
transmit the obscured per-class performance.

24. The apparatus according to claim 23, wherein the generating of the obscured per-class performance based on the updated per-class performance further comprises:
modify the updated per-class performance with a randomly generated noise value.

25. The apparatus according to claim 23, wherein the generating of the obscured per-class performance based on the updated per-class performance further comprises:
encrypt the updated per-class performance with a private encryption key.

26. The apparatus according to claim 25, wherein the obtaining of the per-class performance of the machine learning model further comprises:
receive an encrypted version of the per-class performance; and
decrypt the encrypted version of the per-class performance using the private encryption key to obtain the per-class performance.

27. The apparatus according to claim 16, wherein the per-class performance of the machine learning model comprises a per-class accuracy of the machine learning model.

28. The apparatus according to claim 16, wherein the local data set is only known to the apparatus.

29. The apparatus according to claim 16, wherein the machine learning model comprises an Artificial Neural Network.

30. A method comprising:
receiving a machine learning model, wherein the machine learning model is configured to classify input data into a plurality of classes;
receiving a per-class performance of the machine learning model;
obtaining a data distribution of a local data set;
determining, based on the data distribution of the local data set, if training the machine learning model with the local data set will change the per-class performance of the machine learning model; and
in response to determining that training the machine learning model with the local data set will change the per-class performance of the machine learning model:
training the machine learning model using the local data set.

31. The method according to claim 30, further comprising:
transmitting model updates after training the machine learning model.

32. The method according to claim 30, wherein determining if training the machine learning model with the local data set will change the per-class performance of the machine learning model comprises:
comparing the data distribution of the local data set and the per-class performance of the machine learning model.

33. The method according to claim 32, wherein comparing the data distribution of the local data set and the per-class performance of the machine learning model further comprises:
determining a first ranking for the plurality of classes based on the data distribution of the local data set;
determining a second ranking for the plurality of classes based on the per-class performance;
determining a difference between the first ranking and the second ranking; and
determining that training the machine learning model with the local data set will change the per-class performance of the machine learning model in response to determining that the difference is greater than a first threshold.

34. The method according to claim 33, wherein:
the per-class performance comprises information indicating a performance of the machine learning model for classifying a first class in the plurality of classes; and
the data distribution of the local data set comprises information indicating a proportion of the local data set associated with the first class in the plurality of classes.

35. A non-transitory computer readable medium comprising program instructions that, when executed by an apparatus, cause the apparatus at least to:
receive a machine learning model, wherein the machine learning model is configured to classify input data into a plurality of classes;
receive a per-class performance of the machine learning model;
obtain a data distribution of a local data set;
determine, based on the data distribution of the local data set, if training the machine learning model with the local data set will change the per-class performance of the machine learning model; and
in response to determining that training the machine learning model with the local data set will change the per-class performance of the machine learning model:
train the machine learning model using the local data set.
